(19) United States
(12) Patent Application Publication
(10) Pub. No.: US 2015/0267445 A1
(43) Pub. Date: Sep. 24, 2015

(54) LOCKING MECHANISM FOR CONTAINER AND CONTAINER

(71) Applicants: NANTONG CIMC-SPECIAL TRANSPORTATION EQUIPMENT MANUFACTURE CO., LTD., Nantong (CN); CHINA INTERNATIONAL MARINE CONTAINERS (GROUP)LTD., Shenzhen (CN); CIMC CONTAINERS HOLDING COMPANY LTD., Dongguan (CN)

(72) Inventors: Rong LIU, Nantong (CN); Chunjian DONG, Nantong (CN)

(73) Assignees: MANTONG CIMC-SPECIAL TRANSPORTATION EQUIPMENT MANUFACTURE CO., LTD., Nantong (CN); CHINA INTERNATIONAL MARINE CONTAINERS (GROUP) LTD., Shenzhen (CN); CIMC CONTAINERS HOLDING COMPANY LTD., Dongguan (CN)

(21) Appl. No.: 14/658,326

(22) Filed: Mar. 16, 2015

(30) Foreign Application Priority Data
Mar. 18, 2014 (CN) 201410100798.7

(51) Int. Cl. E05C 17/46; B65D 90/00; B65D 88/12; E05C 19/12; E05B 47/00

(52) U.S. Cl. CPC E05C 17/46; E05C 19/12; E05B 47/0001; B65D 88/12; B65D 90/008

(57) ABSTRACT

The present invention discloses a locking mechanism for a container and a container. The locking mechanism comprises a lock rod constructed such that it can rotate between a first opening position and a first locking position; a locking member, one end of which is fixedly connected to the lock rod, and the other end of which can cooperate with a door of the container when the locking mechanism is mounted onto the container, the locking member can separate from the door when the lock rod rotates to the first opening position, and the locking member can lock the door when the lock rod rotates to the first locking position; a slide block capable of reciprocating movement; and a first drive linkage, one end of which is connected to the slide block, and the other end of which is fixedly connected to the lock rod, wherein the reciprocating movement of the slide block can drive the lock rod to rotate between the first opening position and the first locking position through the first drive linkage. This locking mechanism is characterized by simple operation and low costs, and has an adequate drive distance.

### FIELD OF INVENTION

The present invention relates to the field of container technology, and in particular, to a locking mechanism used for containers and a container having such a locking mechanism.

### BACKGROUND

Containers are commonly used logistic transportation tools, which basically comprise a chassis, two side walls opposite to each other arranged on both sides of the chassis, and two end walls arranged at both ends of the chassis. Usually, at least one of the two end walls may be arranged as a door that can be opened. When cargoes are loaded or unloaded, the door needs to be opened first. However, during the transportation process of containers, the door needs to stay closed to guarantee that cargoes remain intact inside the container. The prior locking mechanism achieves opening and closing of the locking mechanism by means of gear drive, which is inconvenient to operate, requires a high accuracy in production and installation, and features high costs and a limited drive distance.

Therefore, a locking mechanism used for containers and a container having such a locking mechanism need to be provided, so as to solve the problems existing in the prior art.

### SUMMARY OF THE INVENTION

A series of concepts in simplified forms are introduced in the Summary of the Invention, and will be explained in detail in the Detailed Description. The Summary of the Invention of the present invention is not meant to define the critical features and essential technical features of the technical solution for which protection is sought, and also not meant to determine the protection scope of the technical solution for which protection is sought.

In order to solve the abovementioned problems, the present invention discloses a locking mechanism used for containers. The locking mechanism comprises: a lock rod constructed such that it can rotate between a first opening position and a first locking position; a locking member, one end of which is fixedly connected to the lock rod, and the other end of which can cooperate with a door of the container when the locking mechanism is mounted onto the container, wherein the locking member can separate from the door when the lock rod rotates to the first opening position, and the locking member can lock the door when the lock rod rotates to the first locking position; a slide block being capable of reciprocating movement; and a first drive linkage, one end of which is pivotably connected to the slide block, and the other end of which is fixedly connected to the lock rod, wherein the reciprocating movement of the slide block can drive the lock rod to rotate between the first opening position and the first locking position through the first drive linkage.

Preferably, the first drive linkage comprises a first drive lever and a second drive lever that are pivotably connected to each other, the other end of the first drive lever is pivotably connected to the slide block, and the other end of the second drive lever is fixedly connected to the lock rod.

Preferably, a first slot extending perpendicularly to the direction of reciprocating movement of the slide block is arranged on the slide block, one end of the first drive linkage is slidably connected to the slide block in the first slot along the extension direction of the first slot.

Preferably, the locking member comprises an extension rod perpendicular to the lock rod, one end of the extension rod being fixedly connected to the lock rod; a lock hook for cooperating with the door to lock or open the door; a connection rod, both ends of which are pivotally connected to the other end of the extension rod and the other end of the lock hook, respectively; and a guide slot extending in a direction perpendicular to the lock rod, wherein a pivot connecting the connection rod and the lock hook is movably arranged in the guide slot.

Preferably, the lock hook comprises: a hook part; an inclined part, one end of which is connected to the connection rod; and a connection part connecting the hook part and the inclined part, and the hook part and the inclined part bend towards the same direction relative to the connection part.

Preferably, the locking member further comprises a first limit member and a second limit member provided on two sides of the lock hook for limiting the movement of the lock hook between the position of locking the door and the position of opening the door.

Preferably, the locking mechanism further comprises a bottom locking point arranged at the bottom of the door; a bottom rotation shaft parallel with the lock rod; a second drive linkage connecting the bottom rotation shaft and the slide block, wherein the bottom rotation shaft is constructed such that it can rotate between a second opening position and a second locking position during the reciprocating movement of the slide block; a bottom lock hook, one end of which is pivotably connected to the bottom rotation shaft, and the other end of which can cooperate with the bottom locking point when the locking mechanism is mounted onto the container, wherein the bottom lock hook is separated from the bottom locking point when the bottom rotation shaft rotates to the second opening position, and the bottom lock hook is locked to the bottom locking point when the bottom rotation shaft rotates to the second locking position.

Preferably, the second drive linkage comprises a third drive lever and a fourth drive lever that are pivotally connected with each other, wherein the other end of the third drive lever is pivotally connected to the slide block, and the other end of the fourth drive lever is fixedly connected to the bottom rotation shaft.

Preferably, a second slot extending perpendicularly to the direction of reciprocating movement of the slide block is arranged on the slide block, and one end of the second drive linkage is slidably connected to the slide block in the second slot along the extension direction of the second slot.

Preferably, the locking mechanism further comprises a power device connected to the slide block for driving the slide block to move in a reciprocating manner.

Preferably, the locking mechanism comprises two lock rods arranged in parallel, a plurality of locking members, the corresponding number of drive linkages, and a slide block, wherein each of the lock rods is connected with the locking member and the drive linkage.

According to another aspect of the present invention, a container is provided. The container has a door arranged on an end portion thereof, and the container has any of the locking mechanisms as mentioned above, wherein the lock rod of the locking mechanism is arranged on outside of side walls of the container in a manner of being perpendicular to the chassis.

Preferably, an upper end of the door is pivotally connected to a top wall of the container, and the locking mechanism comprises two lock rods which are arranged on outside of two side walls of the container, respectively.

Preferably, one side of the door is pivotably connected to one of a pair of side walls of the container arranged opposite to each other, and the locking mechanism comprises a lock rod arranged on the other one of the side wall pairs of the container.

The locking mechanism according to the present invention converts the movement of the slide block into the rotation of the lock rod through the first drive lever, so as to drive the locking member to lock or open the door. This locking mechanism is characterized by easy operation and low costs. In addition, due to an adequate movement distance of the slide block, this locking mechanism has a sufficient drive distance.

### BRIEF DESCRIPTION OF THE DRAWINGS

The accompanying drawings are included to facilitate a further understanding of the invention, and are incorporated in and constitute a part of this specification. The drawings illustrate embodiments of the invention and, together with the description, serve to explain the principles of the invention. In the drawings,

FIG. 1 illustrates a side view of a container installed with a locking mechanism according to an embodiment of the present invention;

FIG. 2 illustrates a schematic diagram of an up-flap door according to an embodiment of the present invention;

FIG. 3 illustrates a schematic diagram of a side-flap door according to an embodiment of the present invention;

FIG. 4 is a cross sectional view of the container taken along line A-A of FIG. 1, wherein the locking mechanism is in a condition to enable the door open;

FIG. 5 is a cross sectional view of the container taken along line A-A of FIG. 1, wherein the locking mechanism is in a condition to enable the door locked;

FIG. 6 illustrates a schematic diagram of a locking mechanism according to another embodiment of the present invention, wherein the locking mechanism is in a condition to enable the door open;

FIG. 7 illustrates a schematic diagram of a locking mechanism according to another embodiment of the present invention, wherein the locking mechanism is in a condition to enable the door locked.

### DETAILED DESCRIPTION

Great details are to be given in the following discussions for the purpose of rendering more thorough understanding of the present invention. However, it would be apparent to persons skilled in the art that implementation of embodiments of the present invention may be achieved without one or more of these details. In other examples, to avoid confusion with embodiments of the present invention, some technical features well known in the art are not to be described.

To thorough understanding of embodiments of the present invention, detailed structures are to be presented in the following descriptions. Evidently, implementation of embodiments of the present invention is not limited to special details familiar to persons skilled in the art. Preferred embodiments of the present invention are described in details as follows. However, in addition to these detailed descriptions, there may be other embodiments in the present invention.

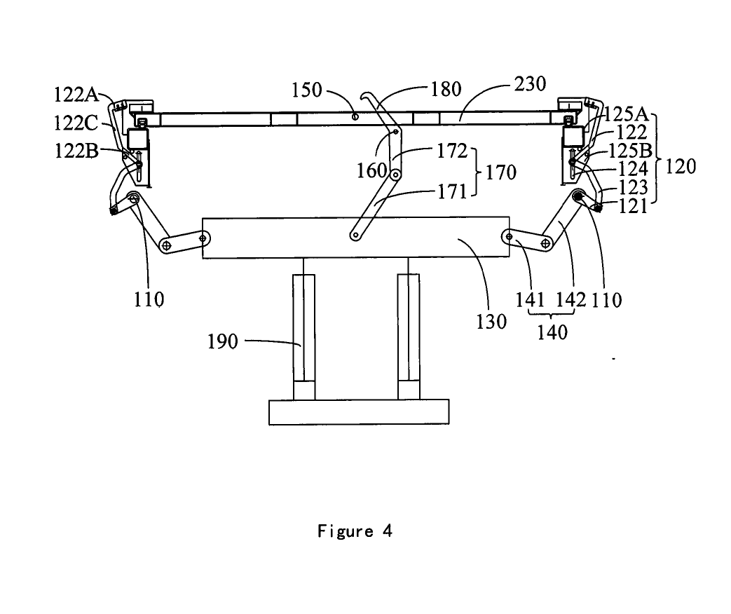

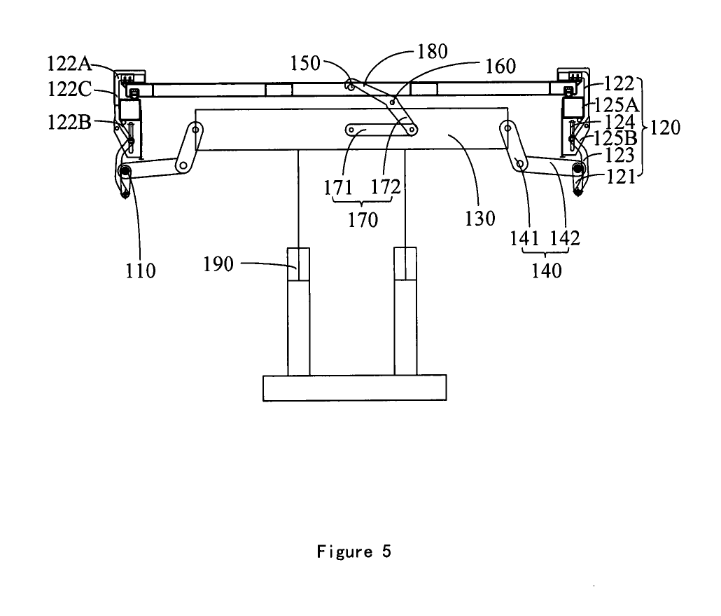

According to an aspect of the present invention, a locking mechanism used for containers is provided. As shown in FIGS. 4 and 5, the locking mechanism may comprise a lock rod 110, a locking member 120, a slide block 130, and a first drive linkage 140. To better describe the locking mechanism, a container installed with such a locking mechanism is firstly described.

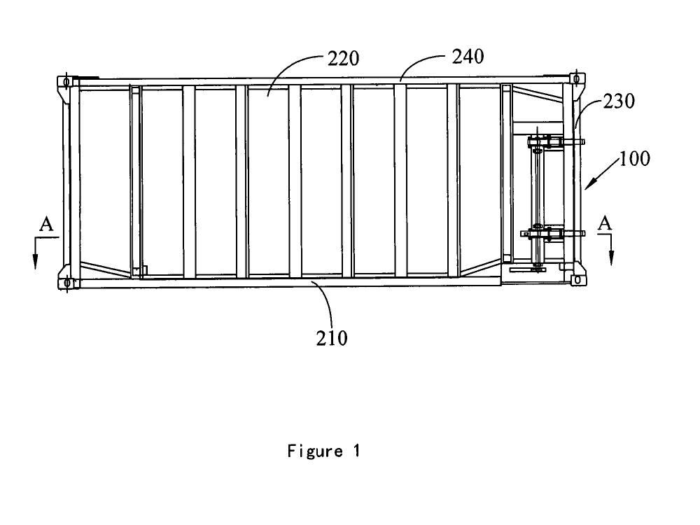

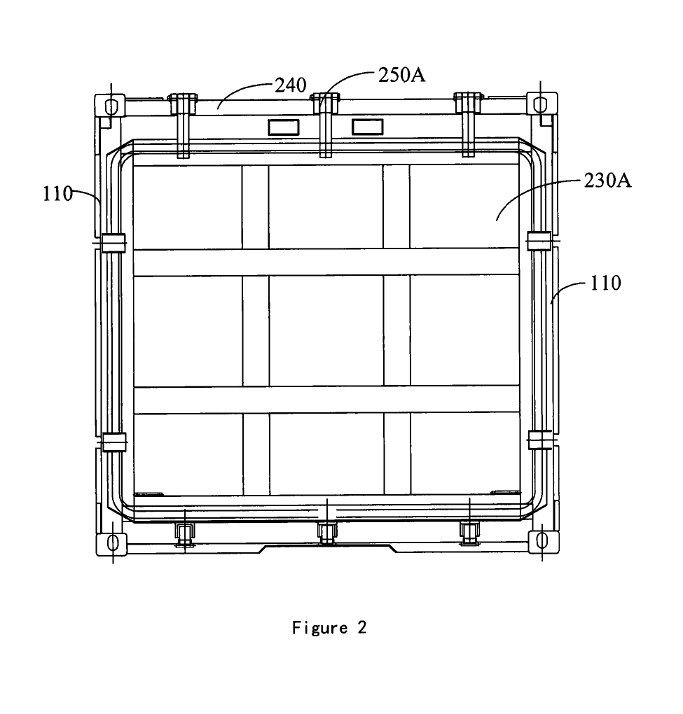

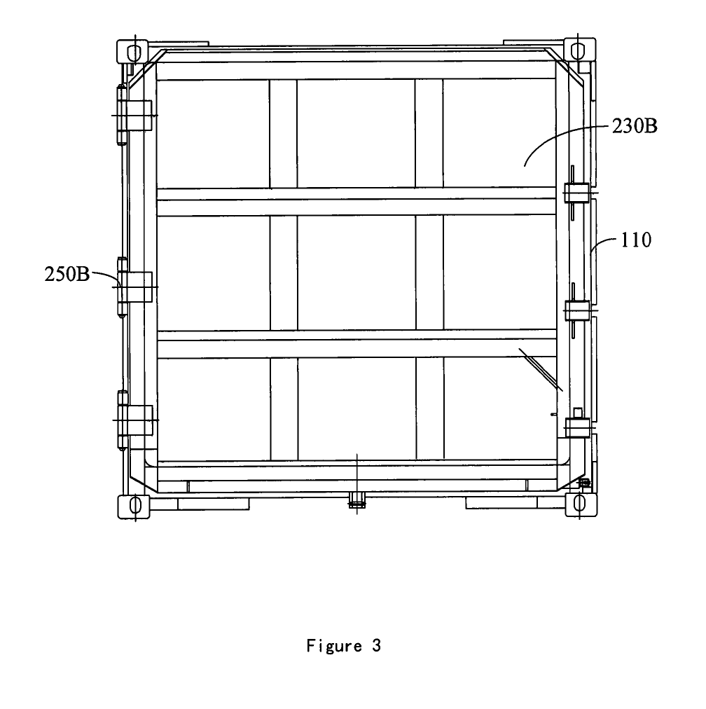

As shown in FIG. 1, the container comprises a chassis 210, two side walls 220, opposite to each other, arranged on both sides of the chassis 210 and extending along the longitudinal direction of the container, and two end walls arranged on the end portions of the chassis 210 connecting the side walls 220 and extending along the transverse direction of the container. It should be noted that the “longitudinal direction” of the container as herein referred to means the length direction of the container, and that the “transverse direction” refers to the horizontal direction perpendicular to the “longitudinal direction”. The container may or may not be provided with a top wall 240. At least one of the two end walls of the container is arranged as a door 230 that can be opened. The door 230 may be arranged in the form of an up-flap door 230A as shown in FIG. 2, the upper end of which may be pivotably connected to the upper-end frame of the container through an up-flap door hinge 250A, etc. In addition, the door 230 may also be arranged in the form of a side-flap door 230B as shown in FIG. 3, that is, one side thereof may be pivotably connected to a side-end frame on the corresponding side of the container through a side-flap door hinge 250B, etc. When different forms are adopted for the door 230 of the container, the locking mechanism mounted onto the container may be mounted in different ways accordingly. This will be discussed in detail hereinafter.

By referring to the accompanying drawings, the locking mechanism provided by the present invention is hereby described in details. As shown in FIGS. 1, 4 and 5, the lock rod 110 may be arranged on outside of the side wall 220 being perpendicular to the chassis 210 of the container, and is constructed such that it can rotate between a first opening position (FIG. 4) and a first locking position (FIG. 5). One or more lock rods 110 may be provided. When the door 230 of the container is arranged in the form of an up-flap door 230A, the lock rods 110 may be provided on outside of both of the two side walls 220 of the container. When the door 230 of the container is arranged in the form of a side-flap door 230B, the lock rods 110 may be provided only on outside of the side wall 220 on the other side of the side-flap door 230, as one side of the side-flap door 230B is connected to the side wall 220 of the container through the hinge 250B etc.

One or more locking members 120 may be provided, and one end of which is fixedly connected to the lock rod 110. It should be noted that one or more locking members 120 connected to each lock rod 110 may be also provided. When there are multiple locking members 120 connected to the lock rod 110, the multiple locking members 120 may be distributed on the lock rod 110 along the vertical direction. The other end of the locking member 120 can cooperate with the door 230 of the container when the locking mechanism is mounted onto the container. The locking member 120 can separate from the door 230 as shown in FIG. 4 when the lock rod 110 rotates to the first opening position. When the lock rod 110 rotates to the first locking position, the locking member 120 can lock the door 230 as shown in FIG. 5.

In order to drive the lock rod 110 to rotate, the locking mechanism may further comprise a slide block 130 and a first drive linkage 140. The slide block 130 may be mounted onto the chassis 210 of the container, and constructed as being capable of reciprocating movement. It should be noted that the invention is not intended to limit the mounting position of the slide block 130, which may be mounted in different positions as required by actual conditions. For example, the slide block 130 may also be mounted onto a matching frame or a matching platform. One end of the first drive linkage 140 is connected to the slide block 130, and the other end of the first drive linkage 140 is fixedly connected to the lock rod 110 through the first drive linkage 140, the reciprocating movement of the slide block 130 is able to drive the lock rod 110 to rotate between the first opening position and the first locking position.

Therefore, a user only needs to move the slide block 130 when operating the locking mechanism, and then the first drive linkage 140 may convert the reciprocating movement of the slide block 130 into the rotation of the lock rod 110 between the first opening position and the first locking position, so as to drive the locking member 120 to separate from or lock the door 230.

It should be noted that the number of the abovementioned various parts included in the locking mechanism may be determined according to actual conditions. As an example, in an embodiment according to the present invention, as shown in FIGS. 4 and 5, the locking mechanism may comprise two lock rods 110 parallel to each other, a slide block 130, a plurality of locking members 120 and a plurality of drive linkages 140. Each lock rod 110 may be connected with one or more locking members 120 and drive linkages 140, and the number of locking members 120 matches that of the drive linkages 140.

As discussed above, the reciprocating movement of the slide block 130 is able to drive the lock rod 110 for rotation through the first drive linkage 140. Arrangement of the first drive linkage may have various forms. As an example, in an embodiment according to the present invention, as shown in FIGS. 4 and 5, the first drive linkage 140 may comprise a first drive lever 141 (a first lock rod drive lever) and a second drive lever 142 (a second lock rod drive lever) that are pivotably connected to each other. The other end of the first drive lever 141 (namely, the end as opposed to the one which is pivotably connected to the second drive lever 142) is pivotably connected to the slide block 130, and the other end of the second drive lever (namely, the end as opposed to the one which is pivotably connected to the first drive lever 141) is fixedly connected to the lock rod 110. In the reciprocating movement of the slide block 130, the lock rod 110 may rotate between the first opening position and the first locking position through the first drive lever 141 and the second drive lever 142.

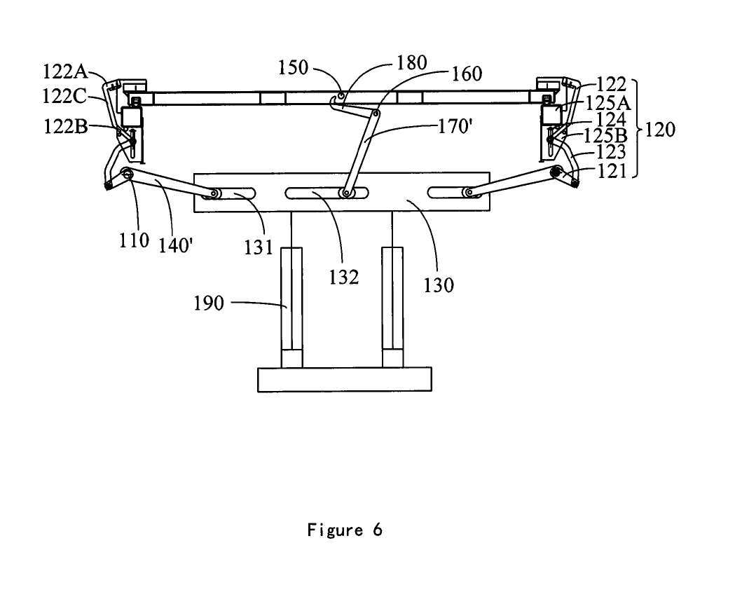

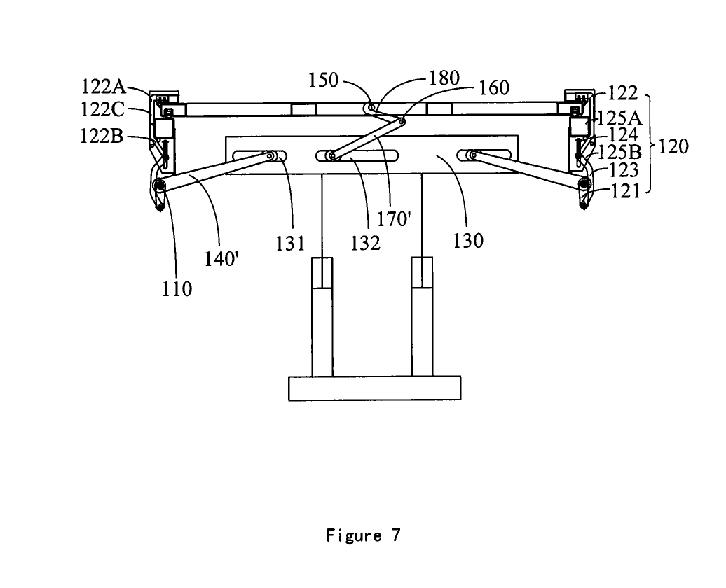

The first drive linkage may also adopt other forms of arrangement. As an example, as shown in FIGS. 6 and 7, in another embodiment according to the present invention, the first drive linkage 140′ may only be a lever. Accordingly, a first slot 131 (a slot of the first drive linkage) may be provided on the slide block 130. The first slot 131 extends within the slide block plane perpendicularly to the direction of reciprocating movement of the slide block 130. One end of the first drive linkage 140′ is slidably connected to the slide block 130 within the first slot 131 along the extension direction of the first slot 131, and the other end of the first drive linkage 140′ is fixedly connected to the lock rod 110. In the reciprocating movement of the slide block 130, one end of the drive linkage 140′ moves with the slide block 130 along the movement direction of the slide block, and accordingly, moves in the first slot 131 along the extension direction of the first slot 131, namely, moving perpendicularly to the movement direction of the slide block 130, thus driving the lock rod 110, which is fixedly connected to the first drive linkage 140′ at the other end of the first drive linkage 140′, to rotate between the first opening position as shown in FIG. 6 and the first locking position as shown in FIG. 7. This form of arrangement of the first drive linkage 140′ may reduce the number of parts.

Arrangement of the locking member 120 may also have various forms. As an example, in an embodiment according to the present invention, as shown in FIGS. 4-7, the locking member 120 may comprise an extension rod 121, a lock hook 122, a connection rod 123 and a guide slot 124. The extension rod 121 is perpendicular to the lock rod 110, and one end of the extension rod 121 is fixedly connected to the lock rod 110, so as to rotate along with the rotation of the lock rod 110. The lock hook 122 is used to cooperate with the door 230 and lock the door 230 as shown in FIGS. 5 and 7 or open the door 230 as shown in FIGS. 4 and 6. Both ends of the connection rod 123 are pivotally connected to the other end of the extension rod 121 and the other end of the lock hook 122, respectively. The guide slot 124 may be arranged in a predetermined position on the chassis 210 of the container, and extend in a direction perpendicular to the lock rod 110. A pivot for connecting the connection rod 123 and the lock hook 122 is movably arranged in the guide slot 124 to enable the end portion of the other end of the lock hook 122 to slide in the guide slot 124. Thus, when the lock rod 110 rotates, the extension rod 121 rotates along with it, so that the pivot connecting the connection rod 123 and the lock hook 122 may be driven to move in the guide slot, enabling the other end of the lock hook 122 to move in the guide slot 124. When the lock rod 110 moves to the first locking position, the end portion of the other end of the lock hook 122 may move in the guide slot 124 to one end far away from the door 230, as shown in FIGS. 5 and 7, in this case, one end of the lock hook may cooperate with the door 230, for example, one end of the lock hook 122 may hook to the edge of the door 230, so as to lock the door 230; when the lock rod 110 rotates to the first opening position, the end portion of the other end of the lock hook 122 may move in the guide slot 124 to one end close to the door 230, as shown in FIGS. 4 and 6, in this case, the lock hook 122 may separate from the door 122.

In order to cooperate with the door 230, the lock hook 122 may comprise a hook part 122A, an inclined part 122B, and a connection part 122C. When the locking mechanism is in the locking position, the hook part 122A of the lock hook 122 may hook to the edge of the door 230, so as to lock the door 230. One end of the inclined part 122B is connected to the connection rod 123. The connection part 122C connects the hook part 122A and the inclined part 122B, and the lock hook 122A and the inclined part 122B bend towards the same direction relative to the connection part 122C, so as to lock the door 230 when the locking mechanism is in a locking condition.

Limit members may be arranged on both sides of the lock hook 122, in order for the lock hook 122, when separated from the door 230, to rotate outward at a predetermined angle relative to the chassis 110 to open the door 230, and when the door 230 needs to be locked, to hook to the door 230 under the driven by the connection rod 123. As shown in FIGS. 4 and 7, the locking member 120 further comprises a first limit member 125A and a second limit member 125B located on both sides of the lock hook 122 for limiting the movement of the lock hook 122 between the position of locking the door 230 and the position of opening the door 230. When the locking mechanism is mounted onto the container, the first limit member 125A may for example be a stop block provided on the inner side of the lock hook 122, and the second limit member 125B may be a stop rod provided on the outer side of the lock hook 122. When the lock rod 110 is in the first locking position, the second limit member 125B cooperates with the inclined part 122B of the lock hook 122, as shown in FIGS. 5 and 7, so as to restrain the lock hook 122A from moving in a direction away from the door 230. When the lock rod 110 rotates towards the first opening position, the pivot connecting the connection rod 123 and the lock hook 122 moves in the guide slot 124 in a direction toward the door 230, in this case, the intervention of the first limit member 125A on the inclined part 122B of the lock hook 122 enables the lock hook 122 to gradually rotate away from the door 230, and due to the existence of the second limit member 125B, the rotation angle of the lock hook 122 will not be too large. When the lock rod 110 rotates to the first opening position, the inclined part 122B of the lock hook 122 is restricted between the first limit member 125A and the second limit member 125B as shown in FIGS. 4 and 6.

In addition, the locking mechanism may further comprise a bottom locking point 150, a bottom rotation shaft 160, a second drive linkage 170 and a bottom lock hook 180. The bottom locking point 150 is arranged at the bottom of the door 230. The bottom rotation shaft 160 is arranged parallel to the lock rod 110, for example, the bottom rotation shaft 160 may be arranged in a predetermined position on the chassis 110, perpendicularly to the chassis 110. The second drive linkage 170 connects the bottom rotation shaft 160 and the slide block 130, and the bottom rotation shaft 160 is constructed so as being able to rotate between a second opening position (FIG. 4) and a second locking position (FIG. 5) when the slide block 130 moves in a reciprocating manner. One end of the bottom lock hook 180 is pivotably connected to the bottom rotation shaft 160, so as to rotate together with the bottom rotation shaft 160. The other end of the bottom lock hook 180 is able to cooperate with the bottom locking point 150 when the locking mechanism is mounted to the container. The bottom lock hook 180 is separated from the bottom locking point 150 when the bottom rotation shaft 160 rotates to the second opening position, as shown in FIGS. 4 and 6, and the bottom lock hook 180 is locked to the bottom locking point 150 when the bottom rotation shaft 160 rotates to the second locking position, as shown in FIGS. 5 and 7.

By further arranging of the bottom locking point 150, the bottom rotation shaft 160, the second drive linkage 170, the bottom lock hook 180, etc. on the bottom, the ability of the locking mechanism to lock the door 230 may be further enhanced. Similarly, one or more bottom rotation shafts 160 may be arranged. In addition, the numbers of the bottom locking point(s) 150, the second drive linkage(s) 170 and the bottom lock hook(s) 180 correspond to those of the bottom rotation shaft(s) 160.

The second drive linkage 170 is similar in structure to the first drive linkage 140. As an example, in an embodiment according to the present invention, the second drive linkage 170 may comprise a third drive lever 171 (a first bottom rotation shaft drive lever) and a fourth drive lever 172 (a second bottom rotation shaft drive lever) that are pivotably connected to each other. The other end of the third drive lever 171 is pivotably connected to the slide block 130, and the other end of the fourth drive lever 172 is fixedly connected to the bottom rotation shaft 160. The second drive linkage 170 may convert the movement of the slide block 130 into the rotation of the bottom rotation shaft 160, thus driving the bottom lock hook 180 to rotate between the second opening position and the second locking position, so as to open or lock the door 230.

Arrangement of the second drive linkage may have other forms. As an example, as shown in FIGS. 6 and 7, in another embodiment according to the present invention, the second drive linkage 170′ may only be a rod. Accordingly, a second slot 132 (a slot for the second drive linkage) may be arranged on the slide block 130. The second slot 132 extends within the slide block plane perpendicularly to the direction of reciprocating movement of the slide block 130. One end of the second drive linkage 170′ is slidably connected to the slide block 130 in the second slot 132 along the extension direction of the second slot 132, and the other end of the second drive linkage 170′ is fixedly connected to the bottom rotation shaft 160. When the slide block 130 moves in a reciprocating manner, one end of the second drive linkage 170′ moves with the slide block 130 along the movement direction of the slide block 130, and accordingly moves in the second slot 132 along the extension direction of the second slot 132, namely moving perpendicularly to the movement direction of the slide block 130, thus driving the bottom rotation shaft 160 fixedly connected to the second drive linkage 170′ at the other end of the second drive linkage 170′ to rotate between the second opening position as shown in FIG. 6 and the second locking position as shown in FIG. 7. This form of arrangement of the second drive linkage 170′ may reduce the number of parts.

In order to achieve automatic control over the locking mechanism in respect of locking the door 230 or separating from the door 230, the locking mechanism may further comprise a power device 190 connected to the slide block 130 for driving the slide block 130 to move in a reciprocating manner. The power device 190 may be one of an oil cylinder, an air cylinder and a motor for supplying power to the movement of the slide block 130. Therefore, in an actual operating process, no manual work is required to move the slide block 130, thus reducing labor intensity. In addition, to facilitate the sliding of the slide block 130, a slide block slot (not shown) may also be arranged on the chassis 210 of the container, so that the slide block 130 can slide in the slot.

The locking mechanism according to the present invention, the first drive lever 140 converts the movement of the slide block 130 into the rotation of the lock rod 110, thus driving the locking member 120 to lock or open the door 230. This locking mechanism is characterized by simple operation and low costs. In addition, since the slide block 130 is allowed an adequate movement distance, this locking mechanism may have a sufficient drive distance.

The present invention has been described through the above embodiments. However, it should be understood that the above embodiments are exemplary and illustrative only and not intended to limit the present invention to the scope of the embodiments as described. In addition, persons skilled in the art would appreciate that the present invention is not confined to the above embodiments, and more variations and modifications may be made according to the teachings of the present invention. These variations and modifications shall all fall within the scope of protection sought for by the present invention.

What is claimed is:

1. A locking mechanism for a container, the locking mechanism comprising:
a lock rod constructed such that it can rotate between a first opening position and a first locking position;
a locking member, wherein one end of the locking member is fixedly connected to the lock rod, and the other end thereof can cooperate with a door of the container when the locking mechanism is mounted onto the container, wherein the locking member can separate from the door when the lock rod rotates to the first opening position, and the locking member can lock the door when the lock rod rotates to the first locking position;
a slide block being capable of reciprocating movement; and
a first drive linkage, one end thereof being connected to the slide block, and the other end thereof being fixedly connected to the lock rod,
wherein the reciprocating movement of the slide block can drive the lock rod to rotate between the first opening position and the first locking position through the first drive linkage.

2. The locking mechanism according to claim 1, wherein the first drive linkage comprises a first drive lever and a second drive lever that are pivotably connected to each other, the other end of the first drive lever is pivotably connected to the slide block, and the other end of the second drive lever is fixedly connected to the lock rod.

3. The locking mechanism according to claim 1, further comprising a first slot extending perpendicularly to the direction of reciprocating movement of the slide block is arranged on the slide block, and one end of the first drive linkage is slidably connected to the slide block in the first slot along the extension direction of the first slot.

4. The locking mechanism according to claim 1, wherein the locking member comprises:
an extension rod perpendicular to the lock rod, one end of the extension rod being fixedly connected to the lock rod;
a lock hook for cooperating with the door to lock or open the door;
a connection rod, both ends of which are pivotally connected to the other end of the extension rod and the other end of the lock hook, respectively; and
a guide slot extending in a direction perpendicular to the lock rod, a pivot connecting the connection rod and the lock hook is movably arranged in the guide slot.

5. The locking mechanism according to claim 4, wherein the lock hook comprises:
a hook part;
an inclined part, one end of which is connected to the connection rod; and
a connection part connecting the hook part and the inclined part, both the hook part and the inclined part bending toward the same direction relative to the connection part.

6. The locking mechanism according to claim 4, wherein the locking member further comprises a first limit member and a second limit member provided on two sides of the lock hook for limiting the movement of the lock hook between the position of locking the door and the position of opening the door.

7. The locking mechanism according to claim 1, wherein the locking mechanism further comprises:
a bottom locking point arranged at the bottom of the door;
a bottom rotation shaft parallel with the lock rod;
a second drive linkage connecting the bottom rotation shaft and the slide block, the bottom rotation shaft being constructed such that it can rotate between a second opening position and a second locking position during the reciprocating movement of the slide block; and
a bottom lock hook, wherein one end thereof is pivotably connected to the bottom rotation shaft, and the other end thereof can cooperate with the bottom locking point when the locking mechanism is mounted onto the container, wherein the bottom lock hook is separated from the bottom locking point when the bottom rotation shaft rotates to the second opening position, and the bottom lock hook is locked to the bottom locking point when the bottom rotation shaft rotates to the second locking position.

8. The locking mechanism according to claim 7, wherein the second drive linkage comprises a third drive lever and a fourth drive lever that are pivotally connected to each other, wherein the other end of the third drive lever is pivotably connected to the slide block, and the other end of the fourth drive lever is fixedly connected to the bottom rotation shaft.

9. The locking mechanism according to claim 7, further comprising a second slot extending perpendicularly to the direction of reciprocating movement of the slide block is arranged on the slide block, and one end of the second drive linkage is slidably connected to the slide block in the second slot along the extension direction of the second slot.

10. The locking mechanism according to claim 1, wherein the locking mechanism further comprises a power device connected to the slide block for driving the slide block to move in a reciprocating manner.

11. The locking mechanism according to claim 1, wherein the locking mechanism comprises two lock rods arranged in parallel, a plurality of locking members and the corresponding number of drive linkages, and a slide block, wherein each of the lock rods is connected with the locking member and the drive linkage.

12. A container having a door arranged on an end thereof, the container having a locking mechanism according to claim 1, wherein the lock rod of the locking mechanism is arranged on outside of side walls of the container in a manner of being perpendicular to the chassis.

13. The container according to claim 12, wherein an upper end of the door is pivotably connected to a top wall of the container, and the locking mechanism comprises two lock rods which are arranged on outside of two side walls of the container, respectively.

14. The container according to claim 12, wherein one side of the door is pivotably connected to one of a pair of side walls arranged opposite to each other, and the locking mechanism comprises a lock rod arranged on the other one of the side wall pairs of the container.
